(19) United States
(12) Patent Application Publication
(10) Pub. No.: US 2024/0306615 A1
(43) Pub. Date: Sep. 19, 2024

(54) AQUATIC SYSTEM WITH FLUID PRESSURE MONITORING AND REGULATION

(71) Applicant: Iwaki America Incorporated, Holliston, MA (US)

(72) Inventors: William Lane Peacock, Amesbury, MA (US); Christopher Collins, Mendon, MA (US); Eric Alan Moore, Pomfret Center, CT (US); Matthew S. Comstock, Waltham, MA (US)

(21) Appl. No.: 18/591,226

(22) Filed: Feb. 29, 2024

Related U.S. Application Data
(60) Provisional application No. 63/452,272, filed on Mar. 15, 2023.

(51) Int. Cl. A01K 63/04

(52) U.S. Cl. CPC A01K 63/047; A01K 63/045

(57) ABSTRACT

A system for housing a supply of aquatic organisms includes a plurality of holding tanks and a subsystem for continuously delivering fluid to each holding tank to ensure a suitable living environment. The subsystem includes a conduit in communication with each holding tank, a pump for driving the fluid through the conduit, a filter for removing impurities in the fluid driven by the pump, and a pressure sensor for measuring the pressure level of fluid traveling within the conduit. A water treatment controller in communication with the pressure sensor monitors the pressure level of fluid in the conduit and compensates for pressure level variances by adjusting the operating speed of the pump to ensure that fluid is delivered to the tanks at a constant flow rate. In this manner, the fluid delivery flow rate remains constant even as particulate blockages begin to form on the filter.

### CROSS-REFERENCE TO RELATED APPLICATIONS

The present invention claims the benefit under 35 U.S.C. 119(e) to U.S. Provisional Patent Application No. 63/452,272, which was filed on Mar. 15, 2023, in the names of William Lane Peacock et al., the disclosure of which is incorporated herein by reference.

### FIELD OF THE INVENTION

The present invention relates generally to the field of scientific research and, more particularly, to aquatic systems in which aquatic animals are housed within rack-mountable holding tanks.

### BACKGROUND OF THE INVENTION

As a part of scientific research, aquatic organisms are routinely studied and modeled. Certain species of aquatic animals, such as zebrafish and xenopus, have been found to be instrumental in achieving technological breakthroughs in the fields of, inter alia, genetic research and drug development.

Traditionally, aquatic organisms are housed in holding tanks that are molded from plastic in specified volumes (e.g., 2-liter, 4.5-liter, and 9-liter tanks). Each size tank is determined to safely house the maximum capacity of a particular type of aquatic animal. In this manner, each holding tank, also commonly referred to in the art as an aquatic tank, is effectively designed to ensure a suitable environment for the organisms housed therein.

To minimize the overall footprint of the space required to maintain a supply of aquatic laboratory animals, a multitude of aquatic tanks is typically stored on a common vertical rack, or frame. Each rack is typically constructed of a rigid and durable material, such as stainless steel, and includes a plurality of open, horizontal shelves on which the aquatic tanks are mounted in a side-by-side relationship. As such, a large quantity of tanks can be stored within a relatively small area, thereby optimizing the efficiency of the usable laboratory space.

In an aquatic system, water is routinely delivered to each of the plurality of aquatic tanks at a consistent flow rate in order to, inter alia, ensure proper water exchange (i.e., turnover rate) within the treated tanks. Appropriate water exchange is required to maintain proper fluid quality within the treated tanks by, among other things, (i) removing or diluting pollutants (e.g., ammonia) and/or (ii) optimizing water quality parameters (e.g., dissolved oxygen (DO) and PH levels). A fluid delivery subsystem typically treats a supply of water based on its intended use and transports the treated water to each of the aquatic tanks through a conduit comprised of a network of interconnected pipes and fittings. In certain systems, used water is extracted from the individual tanks by the fluid delivery subsystem, treated by one or more devices, and then delivered back to the tanks.

A filter is typically integrated into the fluid delivery subsystem within the fluid travel path to remove contaminants, such as food particulates and animal waste, from the water delivered to the aquatic tanks. However, as a considerable amount of contaminants accumulate on the filter, the resultant flow rate of water delivered to the aquatic tanks may decrease, which in turn can significantly compromise the turnover rate of water within each tank. As a result, the purity and overall suitability of the environment for the housed organisms may be compromised.

### SUMMARY OF THE INVENTION

In view thereof, it is an object of the present invention to provide a novel aquatic system for housing laboratory organisms in rack-mounted aquatic tanks.

It is another object of the present invention to provide an aquatic system of the type as described above wherein water is delivered to each of the aquatic tanks at a consistent flow rate in order to maintain proper water exchange and thereby maintain a suitable environment for the housed aquatic organisms.

It is yet another object of the present invention to provide an aquatic system of the type as described above which filters the water delivered to each of the aquatic tanks.

It is still another object of the present invention to provide an aquatic system of the type as described above which compensates for filter blockages that may otherwise adversely affect the consistency of the flow rate of water delivered to the aquatic tanks.

It is yet still another object of the present invention to provide an aquatic system of the type as described above which has a limited number of parts, is inexpensive to manufacture, and is easy to operate.

Accordingly, as one feature of the present invention, there is provided a system for housing a supply of aquatic organisms, the system comprising (a) one or more holding tanks adapted to house the supply of aquatic organisms, and (b) a subsystem for delivering a fluid to each of the one or more holding tanks at a constant flow rate, (c) wherein the subsystem delivers fluid to each of the one or more holding tanks at a pressure level that is monitored and adjusted in order to maintain the delivery of the fluid to each of the one or more holding tanks at the constant flow rate.

Various other features and advantages will appear from the description to follow. In the description, reference is made to the accompanying drawings which form a part thereof, and which is shown by illustration, an embodiment for practicing the invention. The embodiment will be described in sufficient detail to enable those skilled in the art to practice the invention, and it is to be understood that the other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified schematic diagram of an aquatic system for housing laboratory animals, the aquatic system being constructed according to the teachings of the present invention.

### DETAILED DESCRIPTION OF THE INVENTION

### Aquatic System 11

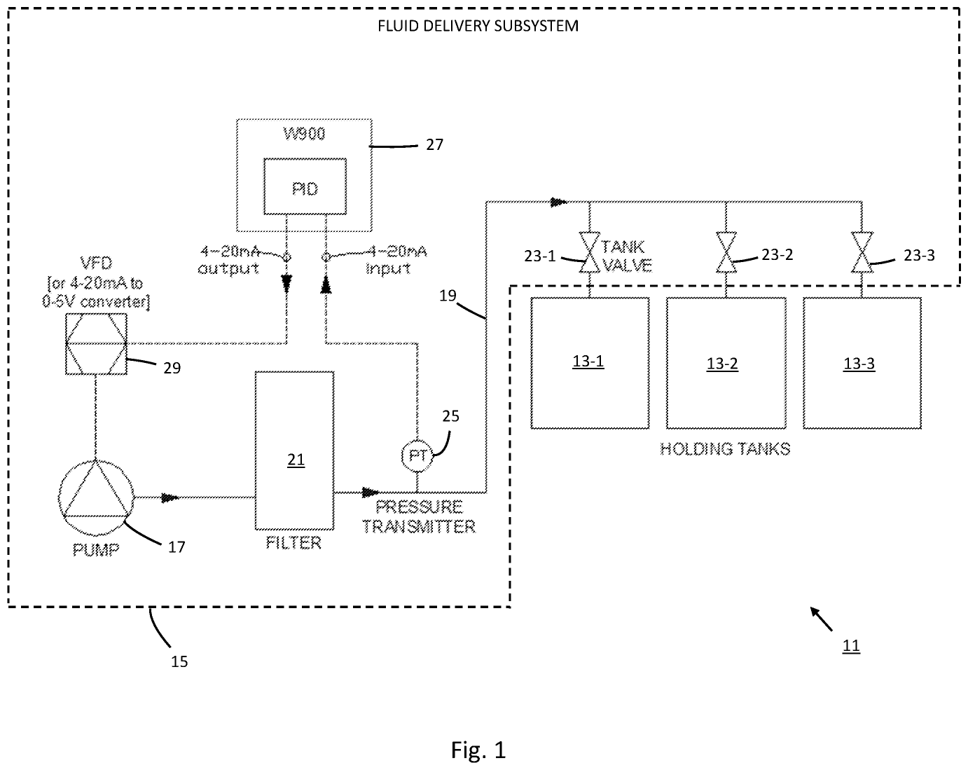

Referring now to FIG. 1, there is shown a schematic diagram of an aquatic system for housing laboratory animals in rack-mounted aquatic tanks, the system being constructed according to the teachings of the present invention and identified generally by reference numeral 11. As will be explained in detail below, system 11 is uniquely designed to ensure that a suitable environment is maintained for the housed aquatic animals.

As can be seen, aquatic system 11 comprises a plurality of holding tanks 13-1 thru 13-3 that is supplied with water from a fluid delivery subsystem 15. In this manner, the proper turnover rate of water retained within each tank 13 is maintained that ensures a suitable living environment for aquatic organisms housed therein.

In the description that follows, water is referenced as the fluid being delivered by subsystem 15 to tanks 13. However, it should be noted that aquatic system 11 is not limited to the delivery and retention of water. Rather, it is to be understood that aquatic system 11 is designed to transport and hold any suitable fluid in which aquatic organisms are routinely housed without departing from the spirit of the present invention.

Each holding, or aquatic, tank 13 is preferably conventional in design and includes a molded plastic tank body on which is mounted a molded plastic lid, or cover. Together, the tank body and lid define an enclosed interior cavity which is appropriately dimensioned to house a supply of aquatic organisms. The particular size (i.e., volume) of the tank body may be varied to accommodate different types of organisms.

In the present embodiment, aquatic system 11 is shown comprising three holding tanks 13. However, it should be noted that three holding tanks 13 are shown only for ease of illustration and understanding. In fact, it is to be understood that aquatic system 11 is readily scalable and could easily accommodate a greater number of holding tanks 13 without departing from the spirit of the present invention.

As referenced briefly above, fluid delivery subsystem 15 supplies holding tanks 13 with treated water in order to maintain a suitable living environment for aquatic organisms housed therein. As principal features of the present invention, fluid delivery subsystem 15 is uniquely designed to (i) deliver water to tanks 13 at a consistent flow rate and (ii) monitor and resolve any fluid delivery blockages. Accordingly, the construction and designed operation of fluid delivery subsystem 15 serve as the primary novel aspects of the present invention.

### Fluid Delivery Subsystem 15

As can be seen, fluid delivery subsystem 15 comprises a water pump 17 that drives a supply of water through a conduit 19 and into each of holding tanks 13-1 thru 13-3. As previously noted, fluid delivery subsystem 15 is uniquely designed to ensure that water transported through conduit 19 travels at a constant flowrate (i.e., a designated fluid delivery setpoint).

A single water pump 17 is shown herein for simplicity purposes and ease of illustration. However, it is to be understood that the particular number and model of water pumps 17 are selected based on the number, size, and arrangement of holding tanks 13 as well as the desired flowrate to be maintained.

Conduit 19 preferably represents any network of interconnected pipes and fittings which enables water to be efficiently delivered to holding tanks 13. The particular configuration of conduit 19 is preferably customized for the laboratory setting in which aquatic system 11 is to be located as well as the specific number and arrangement of holding tanks 13 utilized.

A filter 21 is preferably disposed downstream from pump 17 within the travel path defined by conduit 19. Filter 21 represents any suitable filtration device that removes impurities (e.g., food particles or animal waste) from the water to be delivered to holding tanks 13. As a result, an optimal environment is maintained for the aquatic organisms housed within tanks 13.

A set of tank valves 23-1 thru 23-3 is located in close proximity to the terminal end of the travel path defined by conduit 19 in direct fluid communication with holding tanks 13-1 thru 13-3, respectively. As such, each tank valve 23 regulates the delivery of water into its associated tank 13. As can be appreciated, tank valves 23 can be used to manually shut off the delivery of water to tanks 13.

Over time, filter 21 accumulates an increasing number of particulates. As filter 21 becomes clogged with debris, the flowrate of water delivered through conduit 19 may decrease below the designated setpoint. As a result, the turnover rate of water within tanks 13 may decrease, which in turn may compromise the suitability of the environment for the housed organisms. To remedy this issue, fluid delivery subsystem 15 is uniquely designed to monitor and compensate for blockages in filter 21 to ensure that water transported through conduit 19 travels at a constant flowrate (i.e., the designated fluid delivery setpoint).

More specifically, fluid delivery subsystem 15 comprises a pressure transmitter, or sensor, 25 mounted in conduit 19 downstream from filter 21. Pressure transmitter 25 is designed to measure the pressure of water traveling through conduit 19 downstream from filter 21. As can be appreciated, in the absence of any substantial blockages in filter 21, pump 17 preferably drives water through conduit 19 at a constant rate and pressure level. However, applicant has recognized that as blockages accrue on filter 21, the pressure level measured by pressure sensor 25 proportionally drops, thereby signifying a commensurate drop in the fluid flow rate. Additionally, applicant has recognized that the manual closing of valves 23 can affect fluid flow rates. More specifically, it has been found that the manual closing of one or more valves 23 can create a notable increase in the fluid flowrate to the other (i.e., open) tanks 13 yet, at the same time, reduce the overall system flow rate within conduit 19.

Accordingly, a water treatment controller 27 is disposed in electrical communication with pressure sensor 25. Controller 27 is designed to collect and evaluate water pressure data from sensor 25. As will be explained further below, controller 27 compensates for variances in water pressure within conduit 19 (e.g., due to filter blockages) by adjusting the motor speed of pump 17, thereby returning the flow rate to its designated setpoint.

Water treatment controller 27 is preferably a proportional-integral-derivative (PID) controller which is programmed to use data from pressure sensor 25 to continuously regulate, or modulate, the operation of pump 17 in an accurate and responsive fashion. For instance, controller 27 may of the type manufactured and sold by Walchem, Iwaki America Inc., of Holliston, MA under its W900 series of water treatment controllers.

A variable frequency drive (VFD) 29 electrically connects water treatment controller 27 to water pump 17. VFD 29 is a motor controller that, upon receiving instructions from water treatment controller 27, modifies the speed of the motor for pump 17 by varying the frequency and voltage of power supplied thereto. In this manner, water treatment controller 27 utilizes VFD 29 to regulate the output of pump 17, as needed, to maintain a constant flowrate of clean water to holding tanks 13, which is a principal object of the present invention.

### Designed Operation of Fluid Delivery Subsystem 15

Initially, water treatment controller 27 instructs VFD 29 to drive water pump 17 at a base speed (e.g., 70% of its maximum output). In turn, water pump 17 delivers a supply of treated water at a fixed flowrate through conduit 19 and ultimately into holding tanks 13. As water is transported through conduit 19, pressure sensor 25 periodically measures the pressure of water within conduit 19 (e.g., in pounds per square inch (psi)) and transmits the pressure data to controller 27 for analysis.

As a significant amount of contaminants accumulates on filter 21, the water pressure measured by sensor 25 eventually decreases which, in turn, potentially reduces the flowrate of water delivered to tanks 13 beneath its designated setpoint. Accordingly, using the collected water pressure data, controller 27 calculates the power increase required by pump 17 to return the flowrate back to its designated setpoint. In turn, water treatment controller 27 instructs VFD 29 to drive water pump 17 at an increased speed (e.g., 85% of its maximum output). This ensures that blockages within filter 21 do not prevent the flowrate of water within conduit 19 from falling beneath its setpoint.

As more particulates accumulate on filter 21, the water pressure detected by pressure sensor 25 will continue to fall. In response, water treatment controller 27 instructs VFD 29 to drive water pump 17 at sequentially higher rates of speed in order to maintain the flowrate of water within conduit 19 at its designated setpoint.

However, once VFD 29 is instructed to drive water pump 17 at a threshold rate (e.g., 95% of its maximum output), controller 27 issues an alert signal, such as visual and/or auditory alarm. An operator is thereby notified that filter 21 has become excessively clogged and therefore in immediate need of cleaning or replacement. With filter 21 cleared of clogs, controller 27 instructs VFD 29 to return water pump 17 back to its base speed.

It should also be noted that, on occasion, a tank valve 23 may be temporarily closed to, inter alia, enable an operator to access contents within its associated tank 13. As can be appreciated, the closing of a tank valve 23 can affect the system flow rate. Notably, as referenced above, the closure of one or more tank valves 23 may cause an increase in the water pressure to each of the remaining (i.e., open) tanks 13. At the same time, the overall system flow rate may decrease below its designated setpoint. To compensate for these flow rate fluctuations, controller 27 selectively decreases the rate of pump 17 upon detecting a water pressure variance caused by the closure of one or more tank valves 23, which in turn ensures that the flowrate to the open tanks 13 remains close to its designated setpoint. Once temporarily closed tank valves 23 are reopened, controller 27 detects the pressure decrease in conduit 19 and therefore returns the pump rate back to its normal speed. in this manner, fluid delivery subsystem 15 is designed to compensate for (i.e., smooth out) the various flow rate fluctuations caused by the temporary closure of one or more tank valves 23.

At any point, upon receiving data from transmitter 25 that indicates a notable increase in water pressure, water treatment controller 27 instructs VFD 29 to drive water pump 17 at sequentially lower rates of speed. In this manner, the flowrate of water delivered by subsystem 15 is maintained at its designated setpoint.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A system for housing a supply of aquatic organisms, the system comprising:
(a) one or more holding tanks adapted to house the supply of aquatic organisms; and
(b) a subsystem for delivering a fluid to each of the one or more holding tanks at a constant flow rate;
(c) wherein the subsystem delivers fluid to each of the one or more holding tanks at a pressure level that is monitored and adjusted in order to maintain the delivery of the fluid to each of the one or more holding tanks at the constant flow rate.

2. The system as claimed in claim 1 wherein the subsystem comprises:
(a) a conduit in communication with each of the one or more holding tanks;
(b) a pump for driving the fluid through the conduit and into each of the one or more holding tanks, the pump operating at a speed that drives the fluid through the conduit; and
(c) a filter located downstream from the pump and in communication with the conduit for removing impurities from the fluid delivered to the one or more holding tanks.

3. The system as claimed in claim 2 further comprising a pressure sensor located downstream from the filter and in communication with the conduit for measuring the pressure level of the fluid delivered to each of the one or more holding tanks.

4. The system as claimed in claim 3 further comprising a water treatment controller in electrical communication with the pressure sensor for collecting and monitoring the pressure level measured by the pressure sensor.

5. The system as claimed in claim 4 wherein the water treatment controller compensates for variances in the pressure level measured by the pressure sensor by adjusting the speed of the pump in order to maintain the constant flow rate.

6. The system as claimed in claim 5 wherein the water treatment controller increases the speed of the pump as the measured pressure level drops.

7. The system as claimed in claim 6 wherein the water treatment controller decreases the speed of the pump as the measured pressure level rises.

8. The system as claimed in claim 7 wherein the water treatment controller is a proportional-integral-derivative (PID) controller which is designed to continuously adjust the speed of the pump in order to maintain the constant flow rate.

9. The system as claimed in claim 8 further comprising a variable frequency drive that electrically connects the water treatment controller to the water pump, wherein the water treatment controller utilizes the variable frequency drive to regulate the speed of the pump.

10. The system as claimed in claim 6 wherein the water treatment controller issues an alert signal once the speed of the pump exceeds a threshold rate.

11. The system as claimed in claim 7 further comprising a tank valve in communication with each of the one or more holding tanks, each tank valve being adapted to be manually switched between an open position and a closed position, each tank valve restricting delivery of the fluid into its associated holding tank when in its closed position.

12. The system as claimed in claim 11 wherein the water treatment controller decreases the speed of the pump as the measured pressure level rises when one tank valve is switched into its closed position.

13. A system for delivering a fluid to one or more aquatic tanks, the system comprising:
(a) a conduit;
(b) a pump for driving the fluid through the conduit at a pressure level;
(c) a filter located downstream from the pump and in communication with the conduit for removing impurities from the fluid driven by the pump;
(d) a pressure sensor located downstream from the filter and in communication with the conduit for measuring the pressure level of the fluid driven by the pump; and
(e) a water treatment controller in electrical communication with the pressure sensor, wherein the water treatment controller collects and monitors the pressure level measured by the pressure sensor, wherein the water treatment controller compensates for variances in the pressure level measured by the pressure sensor by adjusting the speed of the pump in order to maintain the delivery of the fluid to the one or more aquatic tanks at a constant flow rate.

14. The system as claimed in claim 13 wherein the water treatment controller increases the speed of the pump as the measured pressure level drops.

15. The system as claimed in claim 14 wherein the water treatment controller decreases the speed of the pump as the measured pressure level rises.

16. The system as claimed in claim 15 wherein the water treatment controller is a proportional-integral-derivative (PID) controller which is designed to continuously adjust the speed of the pump in order to maintain the constant flow rate.

17. The system as claimed in claim 16 further comprising a variable frequency drive that electrically connects the water treatment controller to the water pump, wherein the water treatment controller utilizes the variable frequency drive to regulate the speed of the pump.

18. The system as claimed in claim 14 wherein the water treatment controller issues an alert signal once the speed of the pump exceeds a threshold rate.
